(19) United States
(12) Patent Application Publication
(10) Pub. No.: US 2009/0111467 A1
(43) Pub. Date: Apr. 30, 2009

(54) METHOD FOR REPORTING THE DEVICE CAPABILITY INFORMATION AND TERMINAL DEVICE

(76) Inventors: Xiaoqian Chai, Shenzhen (CN); Kepeng Li, Shenzhen (CN); Jiangshui He, Shenzhen (CN)

Correspondence Address: BRINKS HOFER GILSON & LIONE, P.O. BOX 10395, CHICAGO, IL, 60610, US

(21) Appl. No.: 12/346,041

(22) Filed: Dec. 30, 2008

Related U.S. Application Data
(63) Continuation of application No. PCT/CN2007/002080, filed on Jun. 6, 2007.

(30) Foreign Application Priority Data
Sep. 13, 2006 (CN) 200610154146.7

(51) Int. Cl. H04W 4/00

(52) U.S. Cl. 455/435.1

(57) ABSTRACT

A method for reporting device capability information includes that the device capability information about a terminal device is stored in the terminal device based on a device management tree structure, and the device management tree recording the device capability information is managed by a device management server on a network. The terminal device inquires the device capability information that needs to be reported for operating the service from the device capability information stored based on the device management tree structure, and the inquired device capability information is reported to an application server providing the service to the terminal device. In the method, when the terminal device reports the stored device capability information to a service application server, a network server can manage and maintain the device capability information sets stored in each terminal device dynamically.

### CROSS REFERENCES TO RELATED APPLICATIONS

The present application is a continuation application of PCT/CN2007/002080, filed Jul. 6, 2007, which claims the benefit of Chinese Patent Application No. 200610154146.7, filed Sep. 13, 2006, both of which are hereby incorporated by reference in their entirety.

### BACKGROUND OF THE DISCLOSURE

1. Field of the Technology

The present disclosure relates to a User Agent Profile (UAProf) technology in an Open Mobile Alliance (OMA) technical field, and more particularly to a method for reporting device capability information and a terminal device.

2. Background of the Disclosure

In a communication system, different terminal devices have different capability presentations so a server needs to adapt the capability of a terminal device and the user demand based on a certain processing mode. In order to achieve the objective, the server and the terminal device need to exchange terminal device capability information. The User Agent Profile (UAProf) system in the OMA provides a method for representing the terminal device capability information exchanged between the terminal device and the server where UAProf information is used to express the terminal device capability information so the method can well support wireless application protocol (WAP) service applications.

The terminal device capability information mainly includes hardware information, software information, an explorer program, a network feature, a WAP feature, and a Push feature, which are described as follows:

The hardware information refers to hardware features of the terminal including the type, model, display screen size, supported input methods, and output mode information of the terminal device.

The software information refers to a software operating environment of the terminal, including the operating system of the terminal device, whether the video and audio coding and decoding operations are supported, and user language selection of the terminal device etc.

The explorer program refers to a group of characteristic information describing an HTML browsing application.

In the UAProf system, the capability information relevant to the terminal device is provided to the server so that the server may tailor a service content to be delivered to the terminal device according to the terminal device capability information, thereby achieving the format that best satisfies the terminal device capability and then providing the service content to the terminal device.

FIG. 1 is a block diagram of a main structure of an UAProf system in conventional art, which mainly includes a UAProf client, an origin server, a WAP gateway/proxy cache, and a UAProf repository.

The UAProf client usually refers to a mobile phone, a personal digital assistant (PDA), or other terminal devices supporting the UAProf function when initiating a network session Connect request to the network. The UAProf client transmits a hypertext transfer protocol (HTTP) request message or a wireless session protocol (WSP) request message including the UAProf relevant information (e.g., a uniform resource locator (URL) information about the storage position of the device capability information) of the client to the WAP gateway or the origin server.

The origin server is a service application server supporting the UAProf function, for example, a PUSH server. The origin server may process the HTTP request message including the UAProf relevant information transmitted by the UAProf client, get the UAProf information corresponding to the UAProf client from the UAProf repository according to the UAProf relevant information (for example, the URL information about the storage position of the device capability information) carried in the request message, tailor the service content requested by the terminal according to the got UAProf information, and deliver the service content to the client.

The WAP gateway/proxy cache, in which the WAP gateway is located between the UAProf client and the server, performs the conversion between the WSP protocol and the HTTP protocol, supports the combination of the static device capability information (e.g., the URL information about the storage position of the UAProf client device capability information) and the dynamic device capability information (e.g., the device capability information changed by the UAProf client at that time) reported by the UAProf client, and forwards the combined information to the origin server.

The UAProf repository is adapted to store the UAProf information of each terminal and supports the origin server or the WAP gateway to get the UAProf information corresponding to the terminal according to the UAProf URL information reported by the UAProf client. The UAProf repository may be established or maintained by terminal manufacturers or network operators.

However, in the UAProf system, the UAProf repository usually stores the static capability information of each terminal device, that is, the origin server usually may get only the static capability information about the UAProf client from the UAProf repository according to the URL information about the storage position of the capability information about the UAProf client reported by itself. When the capability information is changed during the process of starting a certain service, the terminal device needs to actively report the changed dynamic capability information so a Device Profile Evolution (DPE) work group in the OMA may further provide a method for reporting the dynamic capability information by the terminal device to the server. However, the origin server only tailors the service content to be delivered to the terminal according to the dynamic capability information reported by the UAProf client, but does not update the dynamic capability information reported by the UAProf client to the UAProf repository. The static UAProf information stored in the UAProf repository is stored for the same type of the terminal device, so it does not update the capability information of the same type of the terminal device according to the change of the individual terminal device capability information. Based on the original UAProf mechanism or the improved DPE mechanism, if the UAProf information about the terminal device is stored on the network, the individualized capability information about each terminal device cannot be stored and maintained, at the same time. Some terminal devices based on a peer to peer (P2P) connection cannot get the UAProf information about the terminal devices.

In order to overcome the technical defects resulting from the UAProf information being stored on the network, a part of or all the UAProf information of the device may be saved in the terminal device. However, as the capability of the terminal device is enhanced and more individualized demands exist, for example, the terminal device performs a firmware update, a software capability part is installed on the terminal device, or a virtual device is installed on the terminal device, the terminal device capability information set may be changed. At this time, the network server needs to update the existing capability information sets on the terminal devices whose the capability information sets are changed. However, the UAProf information about the terminal devices is separately stored in different terminal devices so it is difficult for the network server to manage and maintain the UAProf capability information sets in the terminal devices. That is, the network server cannot add, delete, and update the UAProf capability information sets in the terminal devices in an over the air (OTA) mode.

### SUMMARY OF THE DISCLOSURE

Accordingly, the present disclosure is directed to a method for reporting device capability information, so that when a terminal device reports stored device capability information to a service application server, a network server can dynamically manage and maintain a device capability information set stored in each terminal device.

The present disclosure is further directed to a corresponding terminal device.

The method for reporting device capability information of the present disclosure includes storing the device capability information about a terminal device in the terminal device based on a device management (DM) tree structure, in which the DM tree recording the device capability information is managed by a device management server (DMS) on a network. The terminal device inquiring the device capability information that needs to be reported for running a service from the device capability information stored based on the DM tree structure and reporting the inquired device capability information to an application server providing the service to the terminal device.

The terminal device of the present disclosure includes a storage domain, an inquiring unit, and a capability reporting client. The storage domain is adapted to store terminal device capability information, in which the device capability information in the storage domain is recorded based on a DM tree structure, and the DM tree recording the device capability information is managed by a DMS on a network. The inquiring unit is adapted to inquire the device capability information that needs to be reported for running a service from the device capability information stored in the storage domain. The capability reporting client is adapted to report the device capability information inquired by the inquiring unit to an application server providing the service to the terminal device.

Another method for reporting device capability information of the present disclosure includes storing the device capability information about a terminal device in the terminal device according to a DM tree structure, in which the DM tree recording the device capability information is managed by a DMS on a network, monitoring changed device capability information from the device capability information stored based on the DM tree structure, and reporting the monitored changed device capability information to an application server currently providing the service to the terminal device.

Another terminal device of the present disclosure includes a storage domain, a monitoring unit, and a capability reporting client. The storage domain is adapted to store terminal device capability information, in which the device capability information in the storage domain is recorded based on a DM tree structure, and the DM tree recording the device capability information is managed by a DMS on a network. The monitoring unit is adapted to monitor changed device capability information from the device capability information stored in the storage domain. The capability reporting client is adapted to report the changed device capability information monitored by the monitoring unit to an application server currently providing the service to the terminal device.

In the terminal capability reporting mechanism of the present disclosure, the device capability information stored on the terminal devices is designed to the DM tree structure that can be managed by the DMS, that is, the device capability information is expressed and stored based on the DM tree structure. Thus, in addition to reporting the device capability information through a DPE technology, the terminal devices enable the DMS on the network to dynamically manage and maintain device capability information sets stored in each terminal device in an OTA mode, that is, the DMS may add new device capability information, delete existing device capability information, or update a name or value of existing capability information in the terminal devices in the OTA mode.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of a main structure of an existing UAProf system;

FIG. 2 is a schematic view of a model of the complete management architecture of a DM specification;

FIG. 3 is a flow chart of the principle to implement a first method for reporting device capability information according to an embodiment of the present disclosure;

FIG. 4 shows a specific implementation of the device capability information in a management object (MO);

FIG. 5 is a block diagram of a structure of a first terminal device according to an embodiment of the present disclosure;

FIG. 6 shows a specific structure of an inquiring unit in the terminal device according to an embodiment of the present disclosure;

FIG. 7 is a flow chart of getting the device capability information by an application server before establishing a session;

FIG. 8 is a flow chart of inquiring and reporting the capability information about a terminal device to the application server by the terminal device when the terminal device starts a service;

FIG. 9 shows a DM sub-tree structure of the capability information required by the embodiment added to a DM tree in the terminal device;

FIG. 10 is a flow chart of implementing a second method for reporting the device capability information according to an embodiment of the present disclosure;

FIG. 11 is a block diagram of a structure of a second terminal device according to an embodiment of the present disclosure;

FIG. 12 shows a specific structure of a monitoring unit in the terminal device according to an embodiment of the present disclosure; and

FIG. 13 is a flow chart of monitoring and reporting the changed capability information about a terminal device to the application server by the terminal device when the terminal device operates a service process.

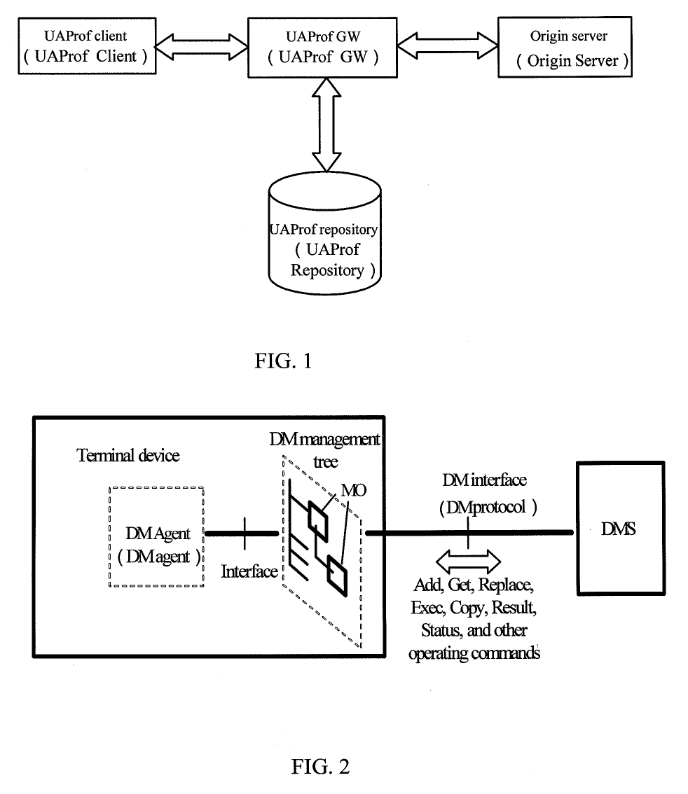

### DETAILED DESCRIPTION OF EMBODIMENTS

In an embodiment of the present disclosure, the capability information of the terminal device is stored as a DM tree structure in a terminal device according to a storage format defined in the Open Mobile Alliance Device Management (OMA DM) technology. Thus, the device capability information stored in the DM tree may be managed by a device management server (DMS) on a network so that the DMS may manage and maintain the device capability information sets stored in terminal devices in an over the air (OTA) mode. That is, the DMS may add new device capability information, delete existing device capability information, or update a name or value of the existing capability information in the terminal devices in the OTA mode.

The OMA DM technology may be used to manage the terminal devices in a wireless network in the OTA mode in which the management operations include software and firmware installation and update, parameter configuration, and error diagnosis. FIG. 2 is a schematic view of a model of the complete management architecture of a DM specification. As shown in FIG. 2, a terminal device explains and executes each management command delivered by the DMS through a DM agent. The DM management tree stored in the terminal device may be considered as an interface through which the DMS manages the terminal device based on the DM protocol. The DM management tree includes a set of basic management objects (MOs), and the DMS controls the terminal device resources by managing each MO in the DM management tree. The management commands through which the DMS operates a MO in the DM management tree include Get command, Replace command, Exec command, Copy command, and Delete command, etc.

An embodiment of the present disclosure provides an implementation mechanism based on the OMA DM technology so that a terminal device may report the device capability information stored in the device, and the DMS may manage and maintain the device capability information sets stored in terminal devices. The device capability information includes static capability information and dynamic capability information about the terminal. The design concept of the embodiment of the present disclosure is as follows: in the DM mechanism, the data stored in the DM tree in the terminal device may be operated and controlled by the DMS on the network and may be used by the terminal device. Based on the point, in the embodiment of the present disclosure, in the terminal capability reporting mechanism, the device capability information stored in the terminal device is designed to the DM tree structure. That is, the device capability information is expressed and stored based on the DM tree structure, in this manner, when the terminal device reports the device capability information, the DMS may manage and maintain the device capability information set in the DM tree structure in the terminal device on the network.

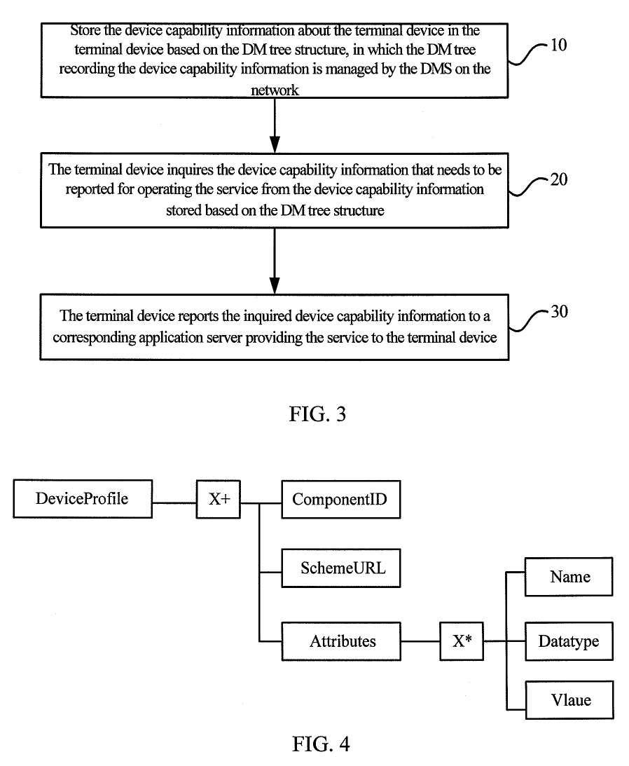

FIG. 3 is a flow chart of the principle to implement a first method for reporting the device capability information according to an embodiment of the present disclosure. The implementing process is described as follows:

In Block 10, the device capability information about the terminal device is stored in the terminal device based on the DM tree structure in which the DM tree recording the device capability information is managed by the DMS on the network (i.e., the DMS not only manages the DM tree structure in the terminal device, but also manages the device capability information recorded in the DM tree).

To update and maintain the device capability information about the terminal device through the DM mechanism, the device capability information about the terminal device needs to be stored based on the DM tree structure. The DM tree structure is an organization mode of the device capability information, which may be, but is not limited to being, implemented as an xml file or a database and may be stored at different positions in the terminal device.

Each piece of the device capability information is an instance of an MO in the DM tree. To enable the terminal device to resolve and report the capability information, enough information is needed in the MO corresponding to each piece of the device capability information. FIG. 4 shows a specific implementation of the device capability information in an MO in which the definitions of the nodes in the MO are as follows:

<DeviceProfile>

| Tree | | | |
|---|---|---|---|
| Occurrence | Format | Minimum Access Right | Value |
| One | Node | Get | N/A |

MO root node storing in device capability information;

<DeviceProfile/X>

| Tree | | | |
|---|---|---|---|
| Occurrence | Format | Minimum Access Right | Value |
| OneOrMore | Node | Get | N/A |

Placeholder node;

<DeviceProfile/X/ComponentID>

| Tree | | | |
|---|---|---|---|
| Occurrence | Format | Minimum Access Right | Value |
| One | Chr | Get | N/A |

Class ID, which is a class name after the device capability is classified, for example, HardwarePlatform;

<DeviceProfile/X/SchemeURL>

| Tree | | | |
|---|---|---|---|
| Occurrence | Format | Minimum Access Right | Value |
| One | Chr | Get | N/A |

Leaf node, which is a Scheme path of a certain class of device capability information;

<DeviceProfile/X/Attributes>

| Tree | | | |
|---|---|---|---|
| Occurrence | Format | Minimum Access Right | Value |
| One | Node | Get | N/A |

Internal node, which is a class attribute set;

<DeviceProfile/X/Attributes/X>

| Tree | | | |
|---|---|---|---|
| Occurrence | Format | Minimum Access Right | Value |
| ZeroOrMore | Node | Get | N/A |

Placeholder node;

<DeviceProfile/X/Attributes/X/Name X>

| Tree | | | |
|---|---|---|---|
| Occurrence | Format | Minimum Access Right | Value |
| One | Chr | Get | N/A |

Leaf node, adapted to identify the attribute name;

<DeviceProfile/X/Attributes/X/Datatype>

| Tree | | | |
|---|---|---|---|
| Occurrence | Format | Minimum Access Right | Value |
| One | Chr | Get | N/A |

Leaf node, adapted to identity a data type of the attribute value;

<DeviceProfile/X/Attributes/X/Value>

| Tree | | | |
|---|---|---|---|
| Occurrence | Format | Minimum Access Right | Value |
| One | Chr | Get | N/A |

Leaf node, adapted to identify the attribute value, which is explained according to the type defined by the Datatype node.

The MO instance storing the device capability information may be updated by the DMS or a device capability MO (DCMO) client in the terminal device. If an operating system of the terminal device provides the updating function, the MO instance may also be updated by the operating system of the terminal device.

In Block 20, the terminal device inquires the device capability information that needs to be reported for running the service from the device capability information stored based on the DM tree structure. Here, the terminal device may determine the device capability information that needs to be reported for running a service when starting the service so as to inquire the corresponding device capability information from the device capability information stored based on the DM tree structure according to the determined device capability information. The terminal device may also inquire the corresponding device capability information from the device capability information stored based on the DM tree structure according to a request message (the request message is adapted to request the terminal device to report the relevant device capability information) delivered by an application server providing the service to the terminal device after starting a service.

In Block 30, the terminal device reports the inquired device capability information to a corresponding application server providing the service to the terminal device. The application server currently providing the service to the terminal device may identify the information form expressed based on a Resource Description Framework (RDF) so when inquiring the corresponding device capability information, the terminal device needs to convert the form of the inquired device capability information to the form based on the RDF format and then reports it to the application server.

The specific working principle of a first terminal device of the embodiment of the present disclosure is described in the following with reference to the principles of the previous method. In the conventional system, even if the device capability information repository is saved in the terminal device, the information is exclusively owned by the information system client and then is directly operated by the capability reporting client. When the capability information needs to be reported, the capability information is directly reported by the capability reporting client and is resolved and used by the corresponding application server. The expression of the current device capability information supports the RDF format, which is a standard format, so the device capability information based on the RDF format reported by the capability reporting client may be directly resolved by the application server.

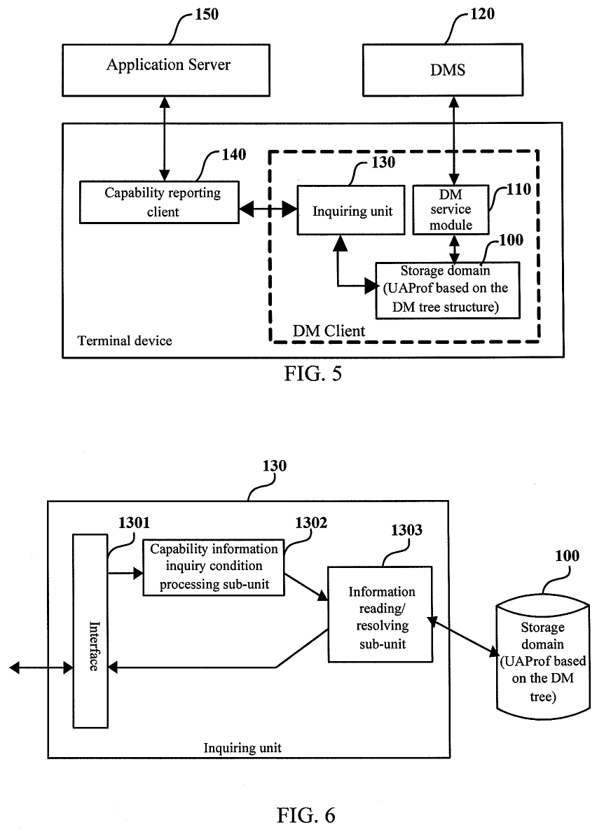

FIG. 5 is a block diagram of a structure of the first terminal device according to an embodiment of the present disclosure. Referring to FIG. 5, a storage domain 100 stores the terminal device capability information based on the DM tree structure. A DM service module 110 performs the basic DM protocol flow resolution and processing, DM session management, DM security management, SyncML coding and decoding, and MO management. A DMS 120 may manage the terminal device in the OTA mode, in which the managed data exists in the DM tree structure, so that based on the OMA DM management protocol, the DMS 120 may maintain and manage the capability information stored based on the DM tree structure in the terminal device storage domain 100 through the DM service module 110 and may also maintain and manage the DM tree structure. An inquiring unit 130 inquires the device capability information that needs to be reported for running the service from the device capability information stored in the storage domain 100. A capability reporting client 140 reports the device capability information about the terminal device to an application server 150 when the service starts. The capability reporting client 140 provides two interfaces. One interface is a reporting interface to the application server 150 and the other interface is an interface for getting the inquired information from the inquiring unit 130. Through the two interfaces, the capability reporting client 140 may directly report the device capability information inquired by the inquiring unit 130 to the application server 150 providing the service to the terminal device when the service starts in which the reporting process may be implemented by using an HTTP message. The application server 150 is a service application server using the device capability information reported by the capability reporting client 140. The application server 150 resolves and uses the device capability information reported by the capability reporting client 140 and tailors the service content to be delivered to the terminal device according to the device capability information.

If the format of the device capability information inquired by the inquiring unit 130 does not accord with the format of the capability information that needs to be reported, an information converting unit converts the form of the device capability information inquired by the inquiring unit 130 to the form expressed based on the RDF in advance and then the capability reporting client 140 reports the information expressed based on the RDF converted by the information converting unit to the application server 150 providing the service to the terminal device.

From the perspective of how to start the inquiry and determine the inquired information, for a first situation, the inquiring unit 130 may include a sub-unit adapted to determine the device capability information that needs to be reported for running a service when the terminal device starts the service and a sub-unit adapted to inquire the corresponding information from the device capability information stored in the storage domain 100 according to the determined device capability information. For a second situation, the inquiring unit 130 may also include a sub-unit adapted to receive a request message delivered by the application server providing the service after the terminal device starts the service in which the request message is adapted to request the terminal device to report the relevant device capability information. The inquiring unit 130 may further include a sub-unit adapted to inquire the corresponding device capability information from the device capability information stored in the storage domain 100 according to the received request message.

From the perspective of the specific process for inquiring the device capability information, a specific structure of the inquiring unit is as shown in FIG. 6. An interface 1301 provides the inquired device capability information to the capability reporting client 140 which may be implemented as a group of API interfaces, Message interfaces, or other types of interfaces. A capability information inquiry condition processing sub-unit 1302 determines the device capability information inquiry request. As the terminal device capability becomes increasingly stronger, the capability information volume also becomes larger for a certain service operated by the terminal device. The required capability information may be a small subset in the device capability information repository stored in the storage domain 100. If all the capability information is reported every time, the network transmission resources are wasted and the processing pressure of the application server 150 is increased. Therefore, the capability information inquiry condition processing sub-unit 1302 needs to determine the capability information that needs to be reported for running a service by the terminal device or determines the capability information that needs to be reported according to the instruction of the application server 150. An information reading/resolving sub-unit 1303 reads and resolves the relevant capability information from the device capability information based on the DM tree structure stored in the storage domain 100 according to the instruction of the capability information inquiry condition processing sub-unit 1302 and transmits the read and resolved device capability information to the capability reporting client 140 through the interface 1301.

The process for inquiring the corresponding capability information from the device capability information stored in the storage domain 100 may be realized in the following two modes.

In the first mode, the capability information inquiry condition processing sub-unit 1302 determines the capability information to be inquired, and determines a uniform resource identifier (URI) information of the capability information in the DM tree. The information reading/resolving sub-unit 1303 locates the capability information in the DM tree in the storage domain 100 according to the URI determined by the capability information inquiry condition processing sub-unit 1302.

In the second mode, the capability information inquiry condition processing sub-unit 1302 determines the capability information to be inquired. The information reading/resolving sub-unit 1303 locates the inquired capability information in the DM tree in the storage domain 100 by traversing the tree according to the capability information to be inquired determined by the capability information inquiry condition processing sub-unit 1302.

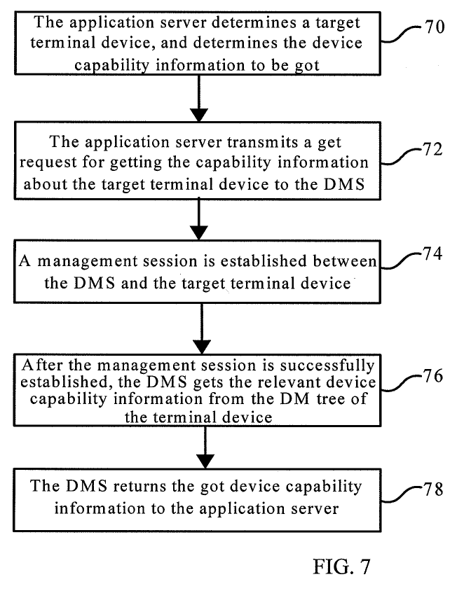

Some services require that the terminal device capability information is obtained before the session between the terminal device and the corresponding application server is established so as to determine how to start the service content. According to the structure of the first terminal device of the embodiment of the present disclosure, the terminal device may get the terminal device capability information before establishing the session with the corresponding application server so that the application server can determine how to start the relevant service. The device capability information exists based on the DM tree structure in the terminal device, and thus, the relevant interface is established between the application server as a request party and the DMS so that the capability information relevant to the terminal device may be inquired through the DMS. FIG. 7 is a flow chart of getting the device capability information before an application server establishes a session. Referring to FIG. 7, in Block 70, the application server providing the service content to the corresponding terminal device determines a target terminal device and determines the device capability information to be got according to the condition of providing the service content. In Block 72, the application server transmits a get request for getting the capability information about the target terminal device to the DMS. In Block 74, a management session is established between the DMS and the target terminal device. In Block 76, after the management session is successfully established between the DMS and the target terminal, the DMS gets the relevant device capability information requested by the application server from the device capability information based on the DM tree structure stored in the storage domain of the terminal device. In Block 78, the DMS returns the got device capability information to the application server.

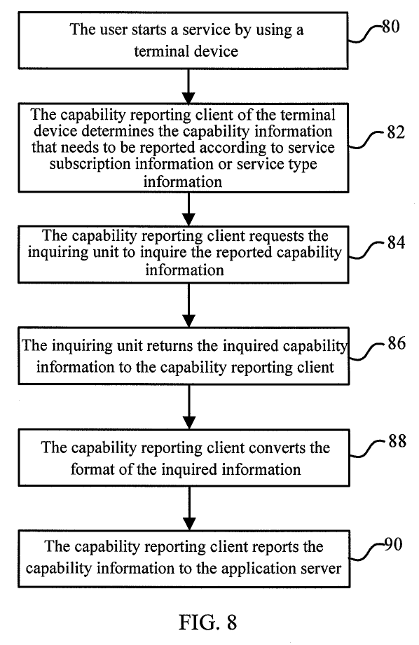

Based on the structure of the first terminal device, the terminal device may inquire and report the relevant capability information about itself to the application server when starting a service. FIG. 8 is a flow chart of inquiring and reporting the capability information about a terminal device to the application server by the terminal device when the terminal device starts a service. As shown in FIG. 8, in Block 80, the user starts a service by using his/her terminal device. In Block 82, the capability reporting client of the terminal device determines the capability information that needs to be reported for operating the started service according to service subscription information or service type information about the started service. In Block 84, the capability reporting client requests the inquiring unit to inquire the reported capability information. In Block 86, the inquiring unit inquires the corresponding capability information from the device capability information based on the DM tree structure stored in the storage domain and returns the inquired capability information to the capability reporting client. In Block 88, the capability reporting client converts the format of the capability information inquired by the inquiring unit to the form expressed based on the RDF form. In Block 90, the capability reporting client reports the capability information in the converted format to the application server.

An embodiment is given in the following to describe the principles of the previous solution in detail with reference to the implementing principles of the first method for reporting the device capability information and the corresponding terminal device of the present disclosure.

It is assumed that a user A prepares to use a subscribed service. The service must be supported by some existing software capability parts, but the software capability parts are not factory set parts in terminal devices so even for terminal devices of the same model, the capability supporting degrees may be different.

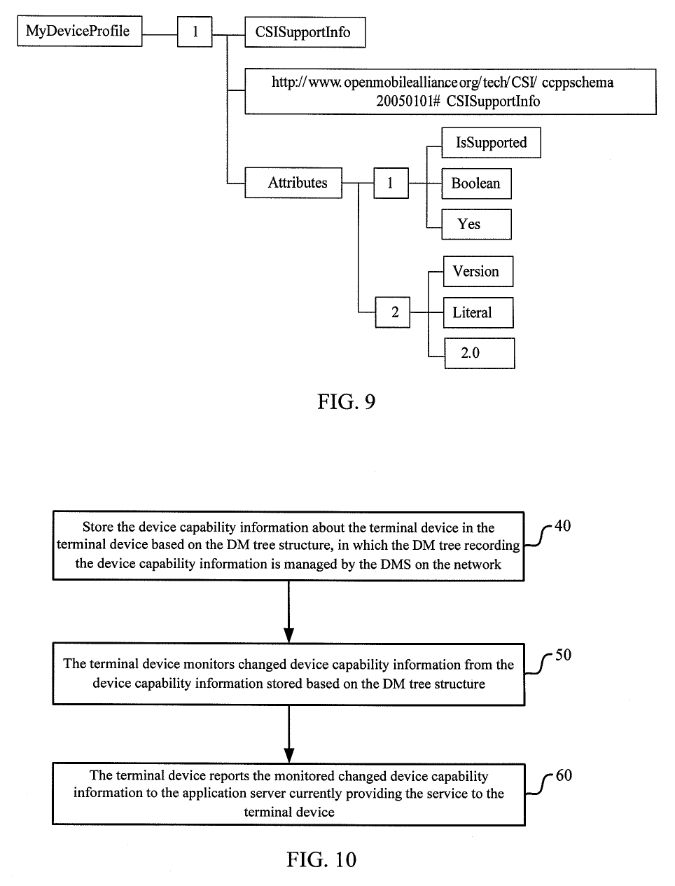

In order to use the service, the user A requests a customer service representative of the operator to provide a remote support. The customer service representative of the operator installs the software capability part through the DM platform. After it is determined that the installation is successful, the customer service representative of the operator adds the capability information to the DM tree in the terminal device through the DM platform. FIG. 9 shows the DM sub-tree structure of the capability information added to the DM tree in the terminal device.

After the user A knows that the software capability part supporting the operation of the service is successfully installed, the user A starts the service. According to the capability information that needs to be provided for running the service determined by the service client, the capability reporting client of the terminal device requests the inquiring unit to inquire the corresponding capability information through the API interface. The inquired capability information is as follows:

GetDeviceProfile(char* infoIDSet=null, int infoCount=0)

where the infoIDSet refers to the capability information set that needs to be acquired and the infoCount refers to the capability information number in the capability information set. If infoIDSet is null, this indicates that all the device capability information needs to be acquired.

According to the request, the inquiring unit inquires the corresponding capability information in the terminal device one by one and returns the inquired information to the capability reporting client in the form of a triplet, which is as follows:

<AttributeID, ComponentID, ResourceValue>

The value is, for example, <CSIVersion, CSISupportInfo, 2.0>, in which CSIVersion is AttributeID in the triad and refers to the version supported by the CSI. CSISupportInfo is ComponentID in the triad and indicates the software capability part described in CSI; the version supported by the CSIVersion is 2.0.

The capability reporting client converts the form of the capability information inquired by the inquiring unit to the xml description complying with the RDF mechanism, which is as follows:

<?xml version=“1.0”?>

<!DOCTYPE rdf:RDF [
<!ENTITY ns-rdf ‘http://www.w3.Org/1999/02/22-rdf-syntax-ns#’>
<!ENTITY ns-prf

‘http://www.openmobilealliance.org/tech/UAPROF/ccppschema-YYYYMMDD#’>

<!ENTITY prf-dt

‘http://www.openmobilealliance.org/tech/UAPROF/xmlschema-YYYYMMDD#’>

<!ENTITY ns-csi

‘http://www.openmobilealliance.org/tech/CSI/ccppschema-YYYYMMDD#’>

]>

rdf:RDF xmlns:rdf=“&ns-rdf;” xmlns:prf=“&ns-prf;” xmlns:csi=“ns-csi;”>

| | |
|---|---|
| <rdf:Description rdf:ID=“MyDeviceProfile”> | <!- Capability |

Profile name -->

<prf:component>
rdf:Description rdf:ID=“CSISupportlnfo”>
<rdf:type rdf:resource=“&ns-csi;CSISupportInfo”/>
<csi:IsSupported rdf:datatype=“&prf-

dt;Boolean”>Yes</csi:IsSupported>

<!-Identifies the name, type, and value of the specific software

capability part -->

<csi:Version rdf:datatype=“&prf-dt;Literal”>2.0</csi:Version>
< !-Identifies the version supported by the specific software

capability part -->

</rdf:Description>
</prf:component>
</rdf:Description>
</rdf:RDF>

Then, the capability reporting client reports the capability information in the converted information format to the application server in which the current profile-diff reporting method may be used. For details of the reporting method, refer to the WAP UAProf specification of the OMA. Next, the application server optimizes the corresponding service content according to the capability information reported by the terminal device and delivers the optimized service content to the terminal device.

The device capability information is usually reported when the service starts, but as the variable device capability information in the terminal device increases, it is necessary to report the device capability information during the service session. To meet the requirement for reporting the device capability information during the service session, the present disclosure provides a second method for reporting the device capability information. FIG. 10 is a flow chart of implementing a second method for reporting the device capability information according to an embodiment of the present disclosure. Referring to FIG. 10, the implementing process is described as follows.

In Block 40, the device capability information (UAProf) about the terminal device is stored in the terminal device based on the DM tree structure in which the DM tree recording the device capability information is managed by the DMS on the network (i.e., the DMS not only manages the DM tree structure in the terminal device, but also manages the device capability information recorded in the DM tree). Details of the implementation of storing the capability information in the terminal device based on the DM tree structure are known from the detailed description of the first method for reporting the device capability information and will not be described again here.

In Bock 50, the terminal device monitors changed device capability information from the device capability information stored based on the DM tree structure. The terminal device may monitor the changed device capability information during the process of running the service currently provided by the corresponding application server to the terminal device. Preferably, the terminal device begins to monitor the changed device capability information when starting a service provided by the corresponding application server and cancels the monitoring on the changed device capability information when the service ends.

In Block 60, the terminal device reports the monitored changed device capability information to the application server currently providing the service to the terminal device. Similarly, before reporting the monitored device capability information, the terminal device needs to convert the form of the monitored device capability information to the form based on the RDF format and then reports it to application server.

For a preferred implementation, the terminal device determines the device capability information relevant to the service from the device capability information stored based on the DM tree structure according to the demand of the service that is currently operated and monitors the changed device capability information from the determined device capability information to save the monitor processing resources of the terminal device.

For another preferred implementation, the terminal device extracts the device capability information relevant to the service from all monitored changed device capability information according to the demand of the service that is currently operated and reports the extracted device capability information to the application server currently providing the service to the terminal device. Compared with the previous implementation, this implementation may waste the monitor processing resources of the terminal device, but the finally reported device capability information is relevant to the service that is currently operated.

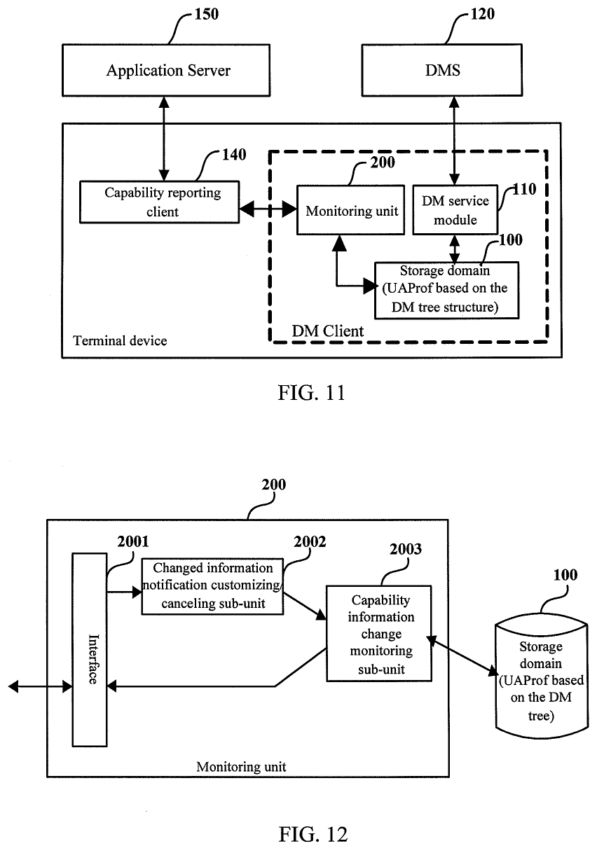

The detailed working principles of a second terminal device of the embodiment of the present disclosure are described in the following with reference to the implementing principles of the second method for reporting the device capability information of the embodiment of the present disclosure. FIG. 11 is a block diagram of a structure of the second terminal device according to an embodiment of the present disclosure. A storage domain 100 stores capability information about the terminal device based on a DM tree structure. A DM service module 110 performs the most basic DM protocol flow resolution and processing, DM session management, DM security management, SyncML coding and decoding, and MO management. A DMS 120 may manage the terminal device in the OTA mode in which the managed data exists based on the DM tree structure so that based on the OMA DM management protocol, the DMS 120 may maintain and manage the capability information stored based on the DM tree structure in the storage domain 100 of the terminal device through the DM service module 110 and may also directly maintain and manage the DM tree structure stored in the storage domain 100. A monitoring unit 200 monitors changed device capability information from the device capability information stored in the storage domain 100, in which the monitoring unit 200 may monitor the changed device capability information from the device capability information stored in the storage domain 100 during the process of running a service currently provided by the corresponding application server. For example, the monitoring unit 200 may begin to monitor the changed device capability information from the device capability information stored in the storage domain 100 when the terminal device starts a service provided by the corresponding application server and cancels the monitoring on the changed device capability information when the service ends. A capability reporting client 140 reports the device capability information monitored by the monitoring unit 200 to the application server 150 currently providing the corresponding service to the terminal device in which the reporting process may be implemented by using an HTTP message. The application server 150 is a service application server using the device capability information reported by the capability reporting client 140 and may resolve and use the device capability information reported by the capability reporting client 140 and tailor the service content being delivered to the terminal device currently according to the device capability information.

If the format of the device capability information monitored by the monitoring unit 200 does not accord with the format of the capability information that needs to be reported, an information converting unit converts the form of device capability information monitored by the monitoring unit 200 to the i form expressed based on the RDF in advance. Then the capability reporting client 140 reports the information expressed based on the RDF converted by the information converting unit to the application server 150 currently providing the service to the terminal device.

In the structure of the terminal device, the monitoring unit 200 may include a sub-unit adapted to determine the device capability information relevant to the service from the device capability information stored in the storage domain 100 according to the demand of the service that is currently operated by the terminal device and may further include a sub-unit adapted to monitor the changed device capability information from the determined device capability information. Thus, the monitoring unit 200 may monitor whether the device capability information relevant to the run service is changed or not during the service operating process to save the monitor processing resource so that capability reporting client 140 may report the changed device capability information relevant to the currently run service to the application server 150.

If the monitoring unit 200 monitors all the changed device capability information from the device capability information stored in the storage domain 100 during the service operating process, the capability reporting client 140 needs to extract the device capability information relevant to the currently run service from the changed capability information monitored by the monitoring unit 200 and report the extracted device capability information to the application server 150 according to the demand of the currently run service. At this time, the capability reporting client 140 may include a sub-unit adapted to extract the device capability information relevant to the currently run service from the changed device capability information monitored by the monitoring unit 200 according to the demand of the service currently operated by the terminal device and may further include a sub-unit adapted to report the extracted device capability information to the application server 150 currently providing the service to the terminal device.

From the perspective of the specific process for monitoring the changed device capability information, a specific structure of the monitoring unit is as shown in FIG. 12. An interface 2001 provides the monitored device capability information to the capability reporting client 140 which may be implemented as a group of API interfaces, Message interfaces, or other types of interfaces. In a certain service session, the capability information about the terminal device may be changed which may affect the operation of the service. At this time, the capability information need to be reported dynamically (i.e., the capability information need to be reported immediately after it is changed). A changed information notification customizing/canceling sub-unit 2002 determines whether to notify the capability reporting client 140 or not when the capability information is changed, and the capability reporting client 140 judges whether the changed capability information affects the currently run service, and determines whether to report the changed capability information. A capability information change monitoring sub-unit 2003 monitors the changed capability information from the device capability information based on the DM tree structure stored in the storage domain 100 when the changed information notification customizing/canceling sub-unit 2002 determines to report the changed capability information to the capability reporting client 140 when the capability information is changed. Further, the capability information change monitoring sub-unit 2003 reports a changed capability information ID and a changed capability information content to the capability reporting client 140 when the changed capability information is monitored.

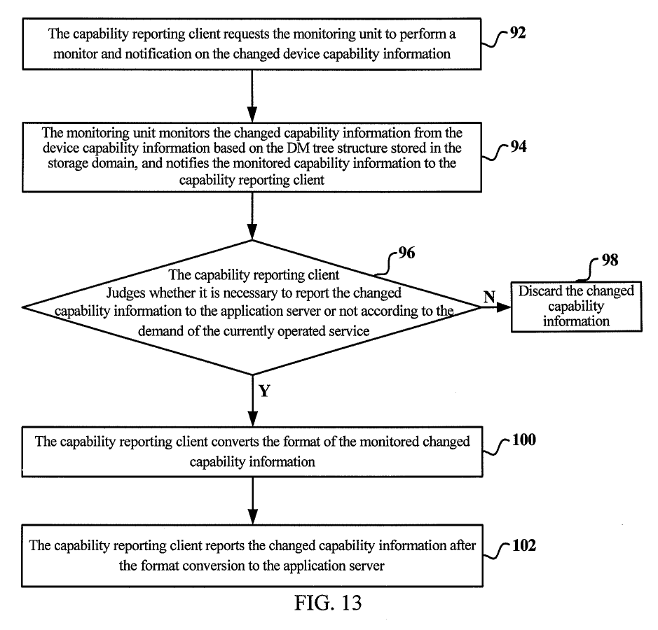

Based on the structure of the second terminal device, the terminal device may report the monitored changed capability information relevant to the run service to the application server during the service operating process. FIG. 13 is a flow chart of monitoring and reporting the changed capability information about a terminal device to the application server by the terminal device when the terminal device operates a service process. In Block 92, the capability reporting client in the terminal device requests the monitoring unit to perform a monitor and notification on the changed device capability information. In Block 94, the monitoring unit monitors the changed capability information from the device capability information based on the DM tree structure stored in the storage domain when the terminal device operates a service session and notifies the monitored capability information to the capability reporting client. In Block 96, the capability reporting client judges whether it is necessary to report the capability information monitored by the monitoring unit to the application server according to the demand of the currently run service. In Block 98, when the judged result is that it is unnecessary to report the monitored capability information to the application server, the capability reporting client discards the monitored changed capability information. In Step 100, when the judged result is that it is necessary to report the monitored capability information to the application server, the capability reporting client converts the form of the monitored capability information to the form expressed based on the RDF mechanism. In Block 102, the capability reporting client reports the changed capability information based on the RDF architecture after the conversion to the application server currently providing the service for the terminal device.

An embodiment is given in the following to describe the principles of the previous solution in detail with reference to the implementing principles of the second method for reporting the device capability information and the corresponding terminal device of the present disclosure.

It is assumed that the user operating experience of a certain service is the best when a memory capacity of a terminal device is larger than 1 M, but currently the memory capacity of the user terminal device is 500 K. Before starting the service, the user does not clear the memory capacity of his/her terminal device. When the service starts, the capability reporting client reports that the memory capacity capability of the terminal device is 500 K. The application server providing the service optimizes the service content according to the memory capacity information of the terminal device and starts the service accordingly.

The service is relatively sensitive to the update of the device capability information so the capability reporting client notifies the monitoring unit in a DM client to monitor the changed device capability information and requires it to notify the monitored capability information. The notifying command transmitted by the capability reporting client to the monitoring unit is transmitted as follows:

SubscribeMOMon(bool is Start, char* ID=null).

where is Start is adapted to instruct the monitoring unit to start or end the monitoring and ID is adapted to instruct which part of the capability information is to be monitored, which is not mandatory.

When using the service, the user finds that the using experience is not quite good. According to the service prompts, the user clears the memory so that the memory capacity is expanded to 1.2 M. The operating system updates the memory capacity information in the capability information based on the DM tree structure stored in the storage domain. Next, the monitoring unit monitors that the memory capacity information is changed in the storage domain and immediately reports the changed information to the capability reporting client. The reported changed information may be organized as a triad, which is as follows:

<AvailableMem, DeviceMemInfo, 1258291>, in which AvailableMem is an AttributeID and refers to the available memory information, DeviceMemInfo refers to AvailableMem adapted to describe a DeviceMemInfo class, and the AvailableMem information is 1258291 (i.e., the available memory capacity is 1.2 M).

The capability reporting client judges according to the demand or type of the currently run service, finds that it is necessary to report the changed information to the corresponding application server, and then converts the format of the changed information and reports it to the application server currently providing the service to the capability reporting client. The application server correspondingly optimizes the service content that is currently provided according to the available memory change of the terminal device and delivers the optimized service content to the terminal device.

After the service is completed, the capability reporting client may request the monitoring unit in the DM client to cancel the monitoring on the changed capability information.

To sum up, in the technical solution of the present disclosure, the device capability information is stored in the terminal device based on the DM tree structure that is managed by the DMS, and the interface through which the stored device capability information based on the DM tree structure may be accessed is provided so that the capability reporting client may get the corresponding device capability information from the capability information stored based on the DM tree structure and report the acquired device capability information to the corresponding application server. The process for getting and reporting the capability information may be performed before the service session begins or immediately after the service session is started. During the service session, the dynamically changed capability information may be reported to the application server. Therefore, on the basis that the terminal device dynamically reports the device capability information, the DMS on the network dynamically manages and maintains the device capability information sets stored in each terminal device. That is, the DMS may add new device capability information, delete existing device capability information, or update a name or value of existing capability information in the terminal device in the OTA mode.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for reporting device capability information, comprising:
inquiring, by a terminal device, device capability information of the terminal device that needs to be reported for running a service from device capability information stored based on a device management (DM) tree structure in the terminal device, wherein a DM tree recording the device capability information is managed by a device management server (DMS) on a network; and
reporting the inquired device capability information to an application server providing the service to the terminal device.

2. The method according to claim 1, wherein the inquiring the device capability information that needs to be reported for running the service further comprises:
starting, by the terminal device, the service;
determining the device capability information that needs to be reported for running the service; and
inquiring, by the terminal device, corresponding information from the device capability information stored based on the DM tree structure according to the determined device capability information.

3. The method according to claim 1, wherein the inquiring, by the terminal device, the device capability information that needs to be reported for running the service further comprises:
receiving, by the terminal device, a request message after starting the service from the application server, wherein the request message is adapted to request the terminal device to report the relevant device capability information; and
inquiring, by the terminal device, the corresponding device capability information from the device capability information stored based on the DM tree structure according to the received request message.

4. The method according to claim 1, wherein before the reporting the inquired device capability information, the method further comprises converting a form of the inquired device capability information to a form expressed based on a Resource Description Framework (RDF).

5. A terminal device, comprising:
a storage domain adapted to store terminal device capability information, wherein the device capability information in the storage domain is recorded based on a device management (DM) tree structure, and a DM tree recording the device capability information is managed by a device management server (DMS) on a network;
an inquiring unit adapted to inquire the device capability information that needs to be reported for running a service from the device capability information stored in the storage domain; and
a capability reporting client adapted to report the device capability information inquired by the inquiring unit to an application server providing the service to the terminal device.

6. The terminal device according to claim 5, wherein the inquiring unit comprises:
a first sub-unit adapted to determine the device capability information that needs to be reported for running the service when the terminal device starts the service; and
a second sub-unit adapted to inquire corresponding information from the device capability information stored in the storage domain according to the determined device capability information.

7. The terminal device according to claim 5, wherein the inquiring unit comprises:
a first sub-unit adapted to receive a request message delivered by the application server providing the service after the terminal device starts the service, wherein the request message is adapted to request the terminal device to report the relevant device capability information; and
a second sub-unit adapted to inquire the corresponding device capability information from the device capability information stored in the storage domain according to the received request message.

8. The terminal device according to claim 5, further comprising an information converting unit adapted to convert a form of the device capability information inquired by the inquiring unit to a form expressed based on a Resource Description Framework (RDF),
wherein the capability reporting client reports the information expressed based on the RDF converted by the information converting unit to the application server providing the service to the terminal device.

9. A method for reporting device capability information, comprising:
monitoring, by a terminal device, changed device capability information from device capability information stored based on a device management (DM) tree structure in the terminal device, wherein the DM tree recording the device capability information is managed by a device management server (DMS) on a network; and
reporting the monitored changed device capability information to an application server currently providing a service to the terminal device.

10. The method according to claim 9, further comprising:
determining, by the terminal device, the device capability information relevant to the service from the device capability information stored based on the DM tree structure according to a demand of a currently run service; and
monitoring the changed device capability information from the determined device capability information.

11. The method according to claim 9, further comprising:
extracting, by the terminal device, the device capability information relevant to the service from the monitored changed device capability information according to a demand of the currently run service; and
reporting the extracted device capability information to the application server currently providing the service to the terminal device.

12. The method according to claim 9 or 11, further comprising:
monitoring, by the terminal device, the changed device capability information when running the service currently provided by the corresponding application server to the terminal device.

13. The method according to claim 12, further comprising:
beginning, by the terminal device, to monitor the changed device capability information when starting the service provided by the corresponding application server; and
canceling the monitoring on the changed device capability information when the service ends.

14. The method according to claim 9, wherein before the reporting the monitored changed device capability information, the method further comprises converting a form of the monitored changed device capability information to a form expressed based on a Resource Description Framework (RDF).

15. A terminal device, comprising:
a storage domain adapted to store terminal device capability information, wherein the device capability information in the storage domain is recorded based on a device management (DM) tree structure, and a DM tree recording the device capability information is managed by a device management server (DMS) on a network;
a monitoring unit adapted to monitor changed device capability information from the device capability information stored in the storage domain; and
a capability reporting client adapted to report the changed device capability information monitored by the monitoring unit to an application server currently providing a service to the terminal device.

16. The terminal device according to claim 15, wherein the monitoring unit comprises:
a first sub-unit adapted to determine the device capability information relevant to the service from the device capability information stored in the storage domain according to a demand of the service currently operated by the terminal device; and
a second sub-unit adapted to monitor the changed device capability information from the determined device capability information.

17. The terminal device according to claim 15, wherein the capability reporting client comprises:
a first sub-unit adapted to extract the device capability information relevant to the service from the changed device capability information monitored by the monitoring unit according to a demand of the service currently operated by the terminal device; and
a second sub-unit adapted to report the extracted device capability information to the application server currently providing the service to the terminal device.

18. The terminal device according to claim 15 or 17, wherein the monitoring unit monitors the changed device capability information when the terminal device operates the service currently provided by the corresponding application server.

19. The terminal device according to claim 18, wherein the monitoring unit begins to monitor the changed device capability information when the terminal device starts the service provided by the corresponding application server and cancels the monitoring on the changed device capability information when the service ends.

20. The terminal device according to claim 15, further comprising an information converting unit adapted to convert the form of the changed device capability information monitored by the monitoring unit to a form expressed based on a Resource Description Framework (RDF), wherein the capability reporting client reports the information expressed based on the RDF converted by the information converting unit to the application server currently providing the service to the terminal device.

21. One or more computer readable media, comprising logic encoded in the computer readable media, the logic when executed operable to implement the method comprising:
inquiring, by a terminal device, device capability information of the terminal device that needs to be reported for running a service from device capability information stored based on a device management (DM) tree structure in the terminal device, wherein a DM tree recording the device capability information is managed by a device management server (DMS) on a network; and
reporting the inquired device capability information to an application server providing the service to the terminal device.

22. One or more computer readable media, comprising logic encoded in the computer readable media, the logic when executed operable to implement the method comprising:
monitoring, by a terminal device, changed device capability information from device capability information stored based on the DM tree structure in the terminal device, wherein the DM tree recording the device capability information is managed by a device management server (DMS) on a network; and
reporting the monitored changed device capability information to an application server currently providing a service to the terminal device.
